(19) United States
(12) Patent Application Publication
(10) Pub. No.: US 2020/0112613 A1
(43) Pub. Date: Apr. 9, 2020

(54) METHOD FOR PROVIDING USER-CENTRIC WORK SPACE

(71) Applicant: Electronics and Telecommunications Research Institute, Daejeon (KR)

(72) Inventors: Hwa-Suk KIM, Daejeon (KR); Juyoung PARK, Daejeon (KR)

(73) Assignee: Electronics and Telecommunications Research Institute, Daejeon (KR)

(21) Appl. No.: 16/593,560

(22) Filed: Oct. 4, 2019

(30) Foreign Application Priority Data
Oct. 4, 2018 (KR) 10-2018-0118509
Nov. 21, 2018 (KR) 10-2018-0144487
Oct. 4, 2019 (KR) 10-2019-0122860

(51) Int. Cl. H04L 29/08; H04L 12/911; H04L 12/26; H04L 12/24

(52) U.S. Cl. CPC H04L 67/16; H04L 47/82; H04L 41/28; H04L 43/08; H04L 67/12

(57) ABSTRACT

Disclosed is a user-centric work space (UCS) providing method performed by a UCS manager for UCS, wherein the UCS manager includes a resource management functional entity (FE), and the UCS providing method includes receiving, by the resource management FE, capability information and status of UCS resources collected by a UCS device, receiving, by the resource management FE, a UCS manager discovery request from a user device, receiving, by the resource management FE, a UCS resource discovery request from the user device, filtering, by the resource management FE, information received from the UCS device as available UCS resource information based on user device information, and sending, by the resource management FE, the filtered information to the user device in response to the UCS resource discovery request.

### CROSS-REFERENCE TO RELATED APPLICATION(S)

This application claims the priority benefit of Korean Patent Application No. 10-2018-0118509 filed on Oct. 4, 2018, Korean Patent Application No. 10-2018-0144487 filed on Nov. 21, 2018, and Korean Patent Application No. 10-2019-0122860 filed on Oct. 4, 2019, in the Korean Intellectual Property Office, the disclosures of which are incorporated herein by reference for all purposes.

### BACKGROUND

### 1. Field of the Invention

One or more example embodiments relate to a technology for providing a user-centric work space (UCS), and more particularly, to a method of providing a UCS by defining requirements for a UCS service.

### 2. Description of the Related Art

Recently, software with communication functions is embedded in various objects including smartphones. Those are called smart devices, and data may be exchanged between such smart devices with the development of Internet of Things (IoT) technology.

However, over and above simple data exchange between smart devices, technology for using smart devices user-centrically has not been fully commercialized. Accordingly, there is a desire for a technology for providing a UCS.

### SUMMARY

An aspect provides a user-centric work space (UCS) providing method that may be applicable to UCS service application scenarios by defining the requirements and capabilities for UCS service.

Another aspect also provides a UCS which may enable a user to use resources of neighboring devices, as necessary, using his or her own smart device, whereby the user convenience and efficiency for works may improve.

According to an aspect, there is provided a UCS providing method performed by a UCS manager for UCS, wherein the UCS manager may include a resource management functional entity (FE), and the UCS providing method may include receiving, by the resource management FE, capability information and status of UCS resources collected by a UCS device, receiving, by the resource management FE, a UCS manager discovery request from a user device, receiving, by the resource management FE, a UCS resource discovery request from the user device, filtering, by the resource management FE, information received from the UCS device as available UCS resource information based on user device information, and sending, by the resource management FE, the filtered information to the user device in response to the UCS resource discovery request.

The UCS manager may further include a resource access control proxy FE and a connection control proxy FE, and the connection control proxy FE may be configured to relay controlling messages for data path management between the user device and the UCS device.

The receiving of the capability information and the status of the UCS resources may include receiving, by the resource management FE, the capability information and status of UCS resources collected by a resource status monitoring FE of a device agent included the UCS device.

The receiving of the UCS manager discovery request may include receiving, by the resource management FE, the UCS manager discovery request from a resource discovery FE of a user agent included in the user device.

The sending of the filtered information to the user device may include sending, by the resource management FE, the filtered information to a resource discovery FE of a user agent included in the user device in response to the UCS resource discovery request.

The UCS manager may further include a resource access control proxy FE, the user device may be a user device used by a predetermined user, and the UCS providing method may further include receiving, by the resource access control proxy FE of the UCS manager, a UCS resource access permission request from the user device of the predetermined user, determining, by the resource access control proxy FE, if additional access control is required for the UCS resources, detecting, by the resource access control proxy FE, a user device of a user who owns UCS resources requiring the additional access control, forwarding, by the resource access control proxy FE, the UCS resource access permission request to the user device of the user who owns the UCS resources, receiving, by the resource access control proxy FE, a resource permission granted from the user device of the user who owns the UCS resources, and forwarding, by the resource access control proxy FE, the resource permission granted to the user device of the predetermined user.

The UCS manager may further include a resource access control proxy FE, and the UCS providing method may further include receiving, by the resource access control proxy FE, a UCS resource permission request from the user device, determining, by the resource access control proxy FE, if the UCS resources can be shared, and sending, by the resource access control proxy FE, a UCS resource permission granted to the user device if the UCS resources can be shared.

The UCS manager may further include a resource access control proxy FE, the user device may be a user device used by a predetermined user, and the UCS providing method may further include receiving, by the resource access control proxy FE, a UCS resource permission request from the user device of the predetermined user, determining, by the resource access control proxy FE, if the UCS resources can be shared and if flow control is required, detecting, by the resource access control proxy FE, a user device of a user who occupies the UCS resources if the UCS resources can be shared and the floor control is required, sending, by the resource access control proxy FE, a resource permission revoked to the user device of the user who occupies the UCS resources, and sending, by the resource access control proxy FE, a resource permission granted to the user device of the predetermined user.

According to another aspect, there is provided a UCS providing method performed by a user device for UCS, wherein the user device performs the UCS providing method through a user agent including a device information management FE, a resource discovery FE, a resource access control FE, and a connection control client FE, and the UCS providing method includes collecting, by the device information management FE, user information and user device information, sending, by the resource discovery FE, a UCS manager discovery request, selecting, by the resource discovery FE, UCS resources required for a UCS service based on UCS resource information received from a UCS manager, sending, by the resource access control FE, an access permission request for the selected UCS resources to the UCS manager, and starting, by the connection control client FE, connection setup with a device agent using the UCS manager.

The user agent may further include a media control FE, and the media control FE may be configured to control receiving or sending media between user devices.

The sending of the access permission request may include sending, by the resource access control FE, the access permission request for the selected UCS resources to a resource management FE included in the UCS manager.

The starting of the connection setup may include starting, by the connection control client FE, the connection setup with the device agent using a connection control proxy FE included in the UCS manager.

The starting of the connection setup may include starting, by the connection control client FE, connection setup with a connection control server FE included in the device agent using the UCS manager.

The sending of the access permission request may include receiving, by the resource access control FE, a UCS resource permission granted from a user device of a user who owns the UCS resources via the UCS manager.

The receiving may include receiving, by the resource access control FE, a resource permission granted from a resource access control FE included in a user device of a user who owns the UCS resources via the UCS manager.

According to another aspect, there is provided a UCS providing method performed by a UCS device for UCS, wherein the UCS device provides a UCS through a device agent including a resource status monitoring FE and a resource advertisement FE, and the UCS providing method may include collecting, by the resource status monitoring FE, capability information and availability status of each UCS resource, and sending, by the resource advertisement FE, the collected capability information and status to a UCS manager.

The device agent may further include a resource capability management FE and a media control FE, the resource capability management FE may be configured to store and manage capability information of UCS resources included in the UCS device, and the media control FE may be configured to control receiving or sending media between a user device and the UCS device.

The sending to the UCS manager may include sending, by the resource advertisement FE, the collected capability information and status to a resource management FE included in the UCS manager.

Additional aspects of example embodiments will be set forth in part in the description which follows and, in part, will be apparent from the description, or may be learned by practice of the disclosure.

### BRIEF DESCRIPTION OF THE DRAWINGS

These and/or other aspects, features, and advantages of the invention will become apparent and more readily appreciated from the following description of example embodiments, taken in conjunction with the accompanying drawings of which:

FIG. 1 illustrates a user-centric work space (UCS) system;

FIG. 2 illustrates a capability framework of a UCS system;

FIG. 3 illustrates a workflow for UCS resource 106 advertisement and discovery.

FIG. 4 illustrates a UCS workflow for configuration of UCS with UCS resources 106 with additional access control required.

FIG. 5 illustrates a UCS workflow for configuration of collaborative UCS with shared resource.

FIG. 6 illustrates a UCS workflow for configuration of collaborative UCS with shared resource requiring floor control.

### DETAILED DESCRIPTION

Hereinafter, some example embodiments will be described in detail with reference to the accompanying drawings. However, various alterations and modifications may be made to the example embodiments. Here, the example embodiments are not construed as limited to the disclosure and should be understood to include all changes, equivalents, and replacements within the idea and the technical scope of the disclosure.

The terminology used herein is for the purpose of describing particular embodiments only and is not intended to be limiting. As used herein, the singular forms are intended to include the plural forms as well, unless the context clearly indicates otherwise. It will be further understood that the terms “comprises” and/or “comprising,” when used in this specification, specify the presence of stated features, integers, steps, operations, elements, components or a combination thereof, but do not preclude the presence or addition of one or more other features, integers, steps, operations, elements, components, and/or groups thereof.

When describing the examples with reference to the accompanying drawings, like reference numerals refer to like constituent elements and a repeated description related thereto will be omitted. In the description of examples, detailed description of well-known related structures or functions will be omitted when it is deemed that such description will cause ambiguous interpretation of the present disclosure.

This disclosure may use the following terms defined elsewhere:
thing: With regard to the Internet of things, this is an object of the physical world (physical things) or the information world (virtual things), which is capable of being identified and integrated into communication networks.
device: With regard to the Internet of things, this is a piece of equipment with the mandatory capabilities of communication and the optional capabilities of sensing, actuation, data capture, data storage and data processing.
gateway: A unit in the Internet of things which interconnects the devices with the communication networks. It performs the necessary translation between the protocols used in the communication networks and those used by devices.
user-centric work space (UCS): A personalized work environment configured by orchestrating local and/or remote ICT resources.

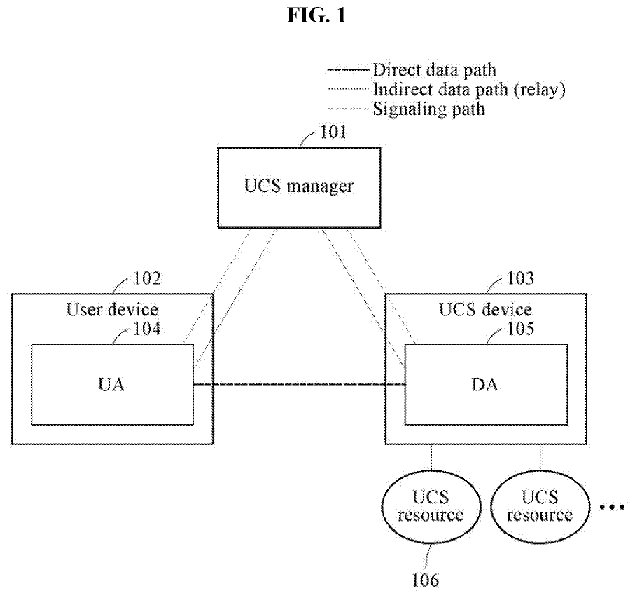

FIG. 1 illustrates a UCS system.

A UCS is one's own work environment by orchestrating near-by and/or remote ICT resources; for example, if there are available nearby office devices (such as monitor, keyboards, printers, speaker, etc.) that are allowed to be used, a user can borrow capabilities of ICT resources and associating them with the service user's smart devices (such as smart phone, smart pad, smart watch and smart glasses) to implement his/her own desktop PC.

A UCS service is a service which enables a user to have his/her own tailored UCS; it can be implemented by UCS system which consists of a user agent (UA) 104 of a user device 102, a device agent (DA) 105 of a UCS device 103, and a UCS manager 101 as shown in FIG. 1. In this example, the UA 104 corresponds to an element of the user device 102, and the DA 105 corresponds to an element of the UCS device 103. Further, UCS resources 106 are within the UCS device 103.

To configure UCS, the user device 102 with the UA 104 firstly discovers a UCS manager 101 and then connects thereto through the UA 104. After successful connection is created, the UA 104 queries the UCS manager 101 about location information of available ICT resources.

Once the UA 104 decides which ICT resources to use, it acquires appropriate permission from the DA 105 through the UCS manager 101. After the permission is granted, one or more data connections are made between the UA 104 and the DA 105 to deliver UI/UX as well as data itself. In case a direct connection between the UA 104 and the DA 105 is not made, then the UCS manager 101 may relay the data connections. The UCS manager 101 periodically gathers location information by polling and pushing ICT resources associated with the DA 105.

The UA 104 is a unit (or a set of units) located in the user device 102 and has the following functions:
providing user information to identify user of the user device 102;
discovering available UCS resources 106;
selecting available UCS resources 106 to configure UCS;
sending/receiving data to/from UCS resources 106; and
controlling the access permission of the UCS resources 106.

The DA 105 is a unit (or a set of units) located in the UCS device 103 and has the following functions:
advertising information and status of UCS resources 106 as a candidate of the UCS resources 106; and
transferring messages between UCS system entities (the UA 104, the UCS manager 101) and device.

The UCS manager 101 is a unit (or a set of units) to mediate UCS resources 106 between the UA 104 and the DA 105 and has the following functions:
managing information and status of UCS resources 106;
managing ownership of UCS resources 106;
monitoring occupancy status of UCS resources 106; and
providing information such as location, capability and ownership of available UCS resources 106 to the UA 104.

Followings are the UA 104 requirements for UCS service.

The UA 104 is required to be installed in each device to use UCS service. The UA 104 is required to have a method to identify globally unique. The UA 104 is required to be attached to network to collaborate with other UCS entities; instances of UCS entities include UCS managers 101, UAs 104, and DAs 105.

The UA 104 is required to have a method of exchanging its capabilities with the UCS manager 101. The UA 104 is required to have an interface that represents the available resource coupled by itself. The UA 104 is required to have a method of requesting the permission of UCS entities owned by others. The UA 104 is required to have a method to discover the capabilities provided by the UCS manager 101; the instances of capabilities provided by the UCS manager 101 include ownership, UCS resources 106. The UA 104 is required to have a method of protecting private information.

Followings are the UCS manager 101 requirements for UCS service.

One UCS manager 101 is required to represent one UCS service session. The UCS manager 101 is recommended to have a method for the collaboration with other UCS manager 101. The UCS manager 101 is required to handle one or more UAs 104 and DAs 105. The UCS manager 101 is required to have a method to identify globally unique. The UCS manager 101 is required to be attached to network for collaborating with other UCS entities. The UCS manager 101 is required to have a method of managing capabilities provided by one or more UAs 104 and DAs 105.

The UCS manager 101 is required to manage the connection status of UCS entities. The UCS manager 101 is required to have a method of storing capability information of one or more DAs 105. The UCS manager 101 is required to provide available DA 105 information according to the location of the UA 104 and user information. The UCS manager 101 is required to provide a mechanism for the UA 104 to acquire and release permission to use other user's UCS devices 103 to extend the range of UCS service.

The UCS manager 101 is required to provide a mechanism for resource bridging between the UA 104 and the DA 105. The UCS manager 101 is required to protect information of the UA 104 and the DA 105. The UCS manager 101 is required to have a method of advertising its capability to the UA 104 and the DA 105 for collaboration. The UCS manager 101 is required to have a method of access control for UCS capabilities.

Followings are the DA 105 requirements for UCS service.

The DA 105 is required to be installed in each UCS device 103 to use UCS service. The DA 105 is required to have a method to identify globally unique. The DA 105 is required to have an interface to notify the change of status of UCS devices 103. The DA 105 is required to have a method of transferring messages from the UA 104 or the UCS manager 101 to UCS devices 103.

The DA 105 is required to have a method of advertising its capabilities through collaborating with the UCS manager 101. The DA 105 is required to be attached to network to collaborate with other UCS components; the UCS components include the UCS manager 101, the DA 105 and the UA 104. The DA 105 is required to provide a means of exchanging status with other UCS components. The DA 105 is required to manipulate ownership of resources of corresponding UCS device 103.

The DA 105 is required to have capability of sharing its resource with other DAs 105. The DA 105 is required to handle its resources based on user permission. The DA 105 is required to have a method of protecting private information. The DA 105 is required to have a method of providing its capabilities partially based on access permission. The DA 105 is required to have a method of processing requests from the UA 104 based on access permission.

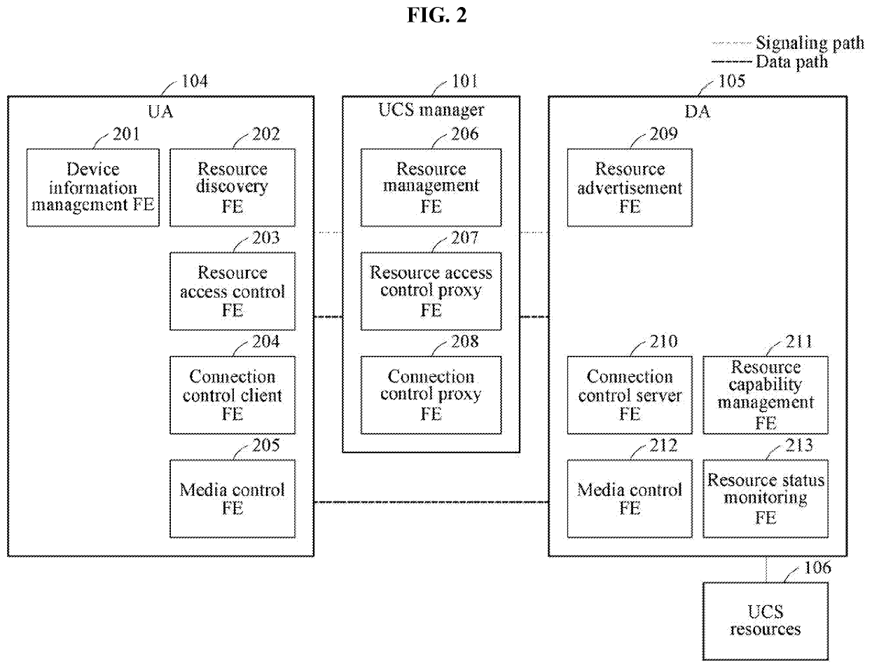

FIG. 2 illustrates a capability framework of a UCS system.

Functional entities (FEs) of the UA 104 correspond to elements included in the UA 104 and are of the following types:
A device information management FE 201 manages information on user and the user device 102 itself. Examples of managed information include user identification and location of the user device 102.
A resource discovery FE 202 discovers UCS resources 106 advertised by the DA 105 in consultation with the UCS manager 101.
A connection control client FE 204 manages the data path to utilize the UCS resources 106 provided by the DA 105.
A resource access control FE 203 obtains the right for accessing UCS resources 106.
A media control FE 205 controls the receiving/sending media between the resources in the device and the user device 102.

FEs of the UCS manager 101 are elements included in the UCS manager 101 and are of the following types:
A resource management FE 206 collects resource information associated with the DA 105 and then provides the collected information to the UA 104.
A connection control proxy FE 208 relays the controlling messages for data path management between the UA 104 and the DA 105. Example cases of the involvement of this FE 208 are when the direct exchange of data path control messages between the UA 104 and the DA 105 is not possible or when a service provider wants to intervene the interaction for billing purposes.
A resource access control proxy FE 207 relays resource access control messages between the UAs 104 and UCS.

FEs of the DA 105 are elements included in the DA 105 and are of the following types:
A resource advertisement FE 209 advertises UCS resource 106 information associated with corresponding DA 105.
A resource capability management FE 211 collects and manages information of UCS resources 106 managed by corresponding DA 105. Examples of information include location, control profile and media type of UCS resources 106.
A resource status monitoring FE 213 monitors whether the UCS resources 106 associated with the DA 105 are available.
A connection control server FE 210 manages the data path to offer UCS resources 106 provided by the DA 105.
A media control FE 212 controls the activity of media transfer between the UA 104 and the DA 105.

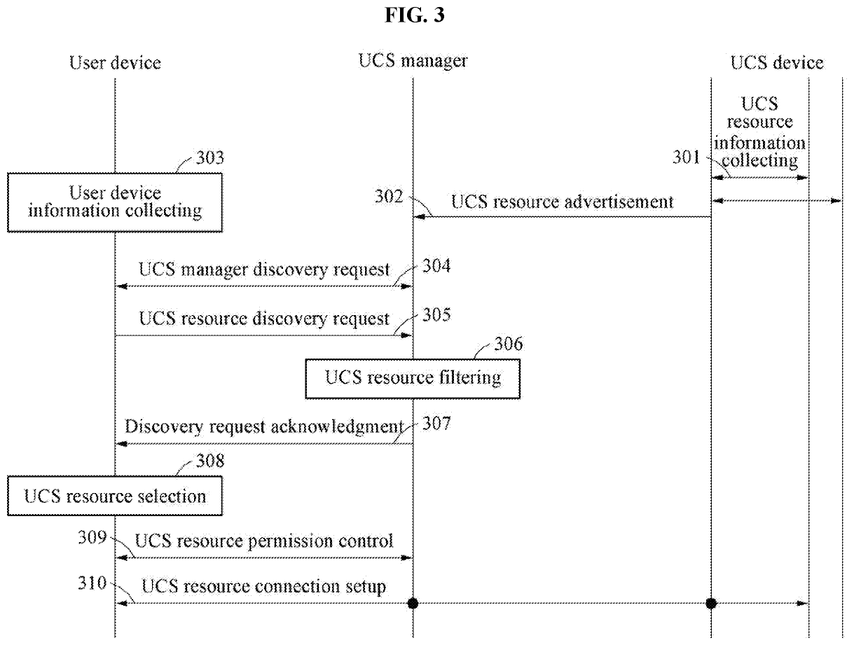

FIG. 3 illustrates a workflow for UCS resource 106 advertisement and discovery.

In UCS resource information collecting operation 301, a DA included in the UCS device 103 collects capability information and status of UCS resources 106 within the UCS device 103 through the resource status monitoring FE 213. The resource capability management FE 211 of the DA stores and manages UCS resource 106 capability information. The resource status monitoring FE 213 of the DA collects capability information and the availability status of each UCS resource 106.

In UCS resource advertisement operation 302, the resource advertisement FE 209 of the DA sends the collected resource capability information and status to a specified UCS manager 101. The resource management FE 206 of the UCS manager 101 stores and manages the capability information and status of the UCS resources 106.

In user device information collecting operation 303, the device information management FE 201 of the UA 104 included in the user device 102 collects user information and the user device 102 information (such as its current location).

In UCS manager discovery request operation 304, the UA 104 discovers the UCS manager 101. For example, the resource discovery FE 202 of the UA 104 sends a UCS manager 101 discovery request to network. The resource management FE 206 of the UCS manager 101 which receives the UCS manager 101 discovery request, will respond. When the resource discovery FE 202 of the UA 104 receives the UCS manager 101 discovery response, the UA 104 may start UCS resource 106 discovery.

In UCS resource discovery request operation 305, the resource discovery FE 202 of the UA 104 requests the UCS manager 101 for discovery of available UCS resources 106.

In UCS resource filtering operation 306, when the UCS resource 106 discovery request is received, the resource management FE 206 of the UCS manager 101 filters available UCS resource 106 information based on the user device 102 information and location.

In discovery request acknowledgment operation 307, the resource management FE 206 of the UCS manager 101 sends a response to the resource discovery request containing the selected UCS resource 106 information to the resource discovery FE 202 of the UA 104.

In UCS resource selection operation 308, the UA 104 selects UCS resources 106 among the received UCS resources 106 to configure the UCS. The resource discovery FE 202 of the UA 104 may select the resources required for the UCS application service or allow a user to select the UCS resources 106.

In UCS resource permission control operation 309, the resource access control FE 203 of the UA 104 requests the access permission for the selected resources and receives the acknowledgement.

In UCS resource connection setup operation 310, the connection control client FE 204 of the UA 104 starts connection setup with the connection control server FE 210 of the DA via the connection control proxy FE 208 of the UCS manager 101.

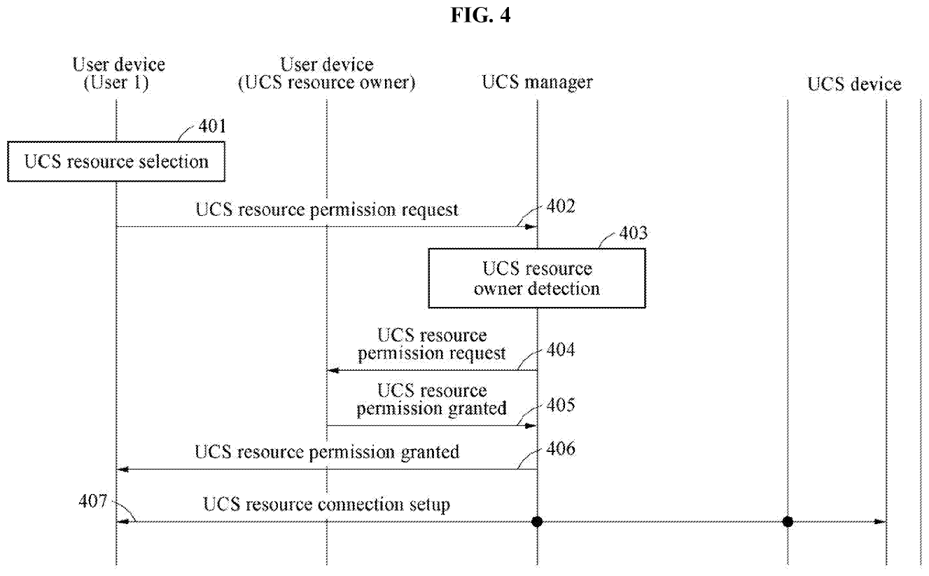

FIG. 4 illustrates a UCS workflow for configuration of UCS with UCS resources 106 with additional access control required.

In UCS resource selection operation 401, after UCS resource advertisement and discovery process of FIG. 3 is completed, the resource discovery FE 202 of the UA included in the user device of User 1 selects UCS resources among the discovered UCS resources 106 to configure the UCS.

In UCS resource permission request operation 402, the resource access control FE 203 included in the user device of User 1 requests the UCS manager 101 for the access permission for the selected resources.

In UCS resource owner detection operation 403, the resource access control proxy to FE 207 of the UCS manager 101 receives the access permission request. If additional access control is required for a specific resource, the resource access control proxy FE 207 of the UCS manager 101 detects a user device of a user who owns that UCS resource.

In UCS resource permission request operation 404, the resource access control proxy FE 207 of the UCS manager 101 forwards the access permission request sent by the user device of User 1 to the user device of the UCS resource owner.

In UCS resource permission granted operation 405, when the user device of the UCS resource owner receives the permission request, the resource access control FE 203 included in the user device of the UCS resource owner decides whether the resource permission is granted or not through interaction with a UA included in the user device of User 1. When granted, the resource access control FE 203 included in the user device of the UCS resource owner sends the UCS resource permission response.

In UCS resource permission granted operation 406, when the UCS resource permission granted is received from the user device of the UCS resource owner, the resource access control proxy FE 207 of the UCS manager 101 forwards the UCS resource permission granted to the resource access control FE 203 included in the user device of User 1 which requests the UCS resource permission.

In UCS resource connection setup operation 407, when the resource access control FE 203 included in the user device of User 1 receives the resource permission granted, the connection control client FE 204 included in the user device of User 1 starts connection setup with the connection control server FE 210 of the DA included in the UCS device 103 via the connection control proxy FE 208 of the UCS manager 101.

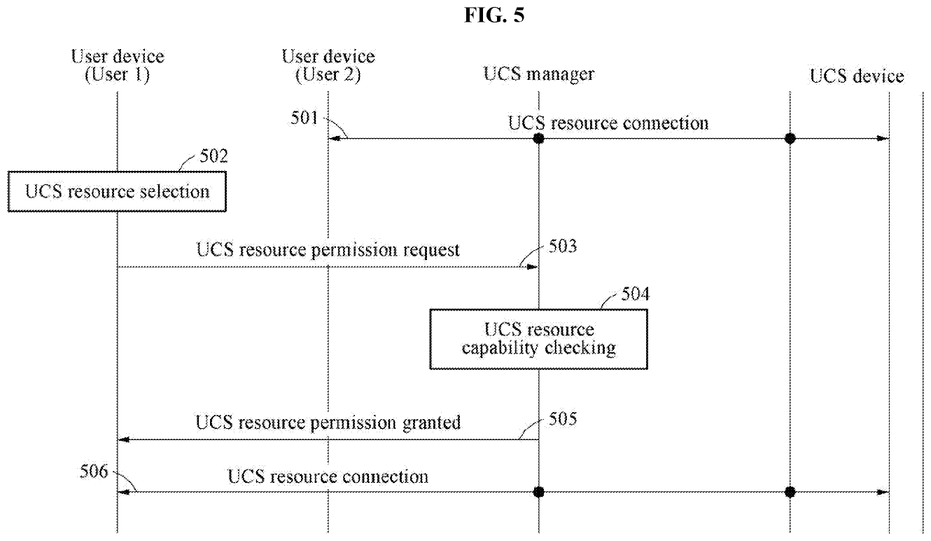

FIG. 5 illustrates a UCS workflow for configuration of collaborative UCS with shared resource.

In UCS resource connection operation 501, a user device of User 2 connects to UCS resource X which is shared media included in the UCS device 103. In this case, User 2 is occupant of the UCS resource X.

In UCS resource selection operation 502, after UCS resource advertisement and discovery process is completed based on a user device of User 1, the resource discovery FE of the UA included in the user device of User 1 selects the UCS resources including the UCS resource X which is shared media among the discovered resources.

In UCS resource permission request operation 503, the resource access control FE included in the user device of User 1 requests the access permission for the UCS resource X.

In UCS resource capability checking operation 504, when the resource access control proxy FE 207 of the UCS manager 101 receives the access permission request, the resource access control proxy FE 207 of the UCS manager 101 checks if the UCS resource X can be shared or not.

In UCS resource permission granted operation 505, if the UCS resource X can be shared with User 1, the resource access control proxy FE 207 of the UCS manager 101 sends a resource permission granted to the user device of User 1.

In UCS resource connection operation 506, when the resource access control FE included in the user device of User 1 receives the resource permission granted, the connection control client FE included in the user device of User 1 starts connection setup with the connection control server FE 210 of the DA included in the UCS device 103 via the connection control proxy FE 208 of the UCS manager 101. The UA included in the user device of User 1 starts UCS service.

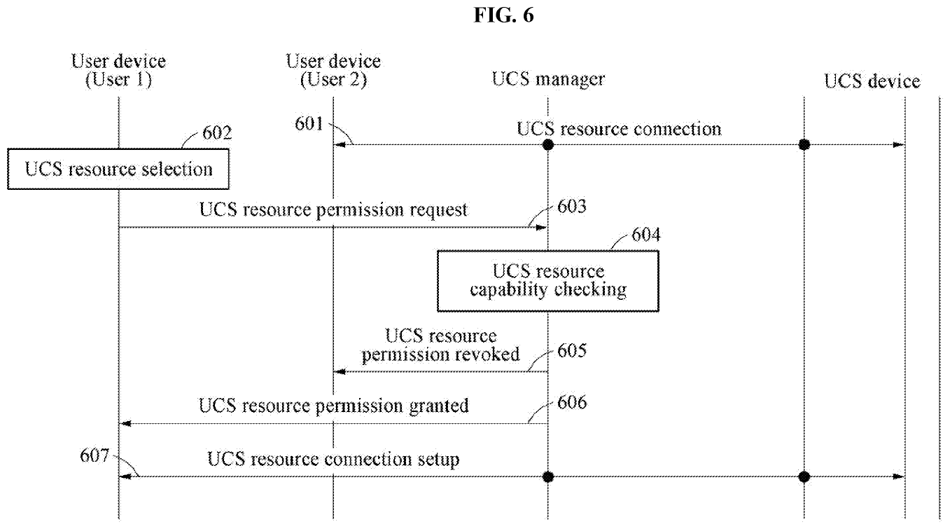

FIG. 6 illustrates a UCS workflow for configuration of collaborative UCS with shared resource requiring floor control.

In UCS resource connection operation 601, the user device of User 2 connects to UCS resource X which is shared media included in the UCS device 103 and requiring flow control. In this case, User 2 is occupant of the UCS resource X.

In UCS resource selection operation 602, after UCS resource advertisement and to discovery process is completed based on the user device of User 1, the resource discovery FE included in the user device of User 1 selects the UCS resources including the UCS resource X which is a shared media among the discovered UCS resources.

In UCS resource permission request operation 603, the resource access control FE included in the user device of User 1 requests the access permission for the UCS resource X.

In UCS resource capability checking operation 604, when the resource access control proxy FE 207 of the UCS manager 101 receives the access permission request, if the resource can be shared and flow control is required, the resource access control proxy FE 207 of the UCS manager 101 detects the occupant of the UCS resource X.

In UCS resource permission revoked operation 605, in order to switch the floor control, the resource access control proxy FE 207 of the UCS manager 101 sends a resource permission revoke to the resource access control FE of the UA included in the user device of User 2.

In UCS resource permission granted operation 606, the UCS manager 101 sends a resource permission granted to the resource access control FE included in the user device of User 1.

In UCS resource connection setup operation 607, when the resource permission granted is received by the resource access control FE included in the user device of User 1, the connection control client FE included in the user device of User 1 starts connection setup with the connection control server FE 210 of the DA via the connection control proxy FE 208 of the UCS manager 101. The UA included in the user device of User 1 starts UCS service.

According to example embodiments, it is possible to provide a UCS providing method that may be applicable to UCS service application scenarios by defining the requirements and capabilities for UCS service.

According to example embodiments, it is possible to provide a UCS which may enable a user to use resources of neighboring devices, as necessary, using his or her own smart device, whereby the user convenience and efficiency for works may improve.

The components described in the example embodiments may be implemented by hardware components including, for example, at least one digital signal processor (DSP), a processor, a controller, an application-specific integrated circuit (ASIC), a programmable logic element, such as a field programmable gate array (FPGA), other electronic devices, or combinations thereof. At least some of the functions or the processes described in the example embodiments may be implemented by software, and the software may be recorded on a recording medium. The components, the functions, and the processes described in the example embodiments may be implemented by a combination of hardware and software.

The units described herein may be implemented using a hardware component, a software component and/or a combination thereof. A processing device may be implemented using one or more general-purpose or special purpose computers, such as, for example, a processor, a controller and an arithmetic logic unit (ALU), a DSP, a microcomputer, an FPGA, a programmable logic unit (PLU), a microprocessor or any other device capable of responding to and executing instructions in a defined manner. The processing device may run an operating system (OS) and one or more software applications that run on the OS. The processing device also may access, store, manipulate, process, and create data in response to execution of the software. For purpose of simplicity, the description of a processing device is used as singular; however, one skilled in the art will appreciated that a processing device may include multiple processing elements and multiple types of processing elements. For example, a processing device may include multiple processors or a processor and a controller. In addition, different processing configurations are possible, such a parallel processors.

The software may include a computer program, a piece of code, an instruction, or some combination thereof, to independently or collectively instruct or configure the processing device to operate as desired. Software and data may be embodied permanently or temporarily in any type of machine, component, physical or virtual equipment, computer storage medium or device, or in a propagated signal wave capable of providing instructions or data to or being interpreted by the processing device. The software also may be distributed over network coupled computer systems so that the software is stored and executed in a distributed fashion. The software and data may be stored by one or more non-transitory computer readable recording mediums.

The methods according to the above-described example embodiments may be recorded in non-transitory computer-readable media including program instructions to implement various operations of the above-described example embodiments. The media may also include, alone or in combination with the program instructions, data files, data structures, and the like. The program instructions recorded on the media may be those specially designed and constructed for the purposes of example embodiments, or they may be of the kind well-known and available to those having skill in the computer software arts. Examples of non-transitory computer-readable media include magnetic media such as hard disks, floppy disks, and magnetic tape; optical media such as CD-ROM discs, DVDs, and/or Blue-ray discs; magneto-optical media such as optical discs; and hardware devices that are specially configured to store and perform program instructions, such as read-only memory (ROM), random access memory (RAM), flash memory (e.g., USB flash drives, memory cards, memory sticks, etc.), and the like. Examples of program instructions include both machine code, such as produced by a compiler, and files containing higher level code that may be executed by the computer using an interpreter. The above-described devices may be configured to act as one or more software modules in order to perform the operations of the above-described example embodiments, or vice versa.

While this disclosure includes specific examples, it will be apparent to one of ordinary skill in the art that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner and/or replaced or supplemented by other components or their equivalents. Therefore, the scope of the disclosure is defined not by the detailed description, but by the claims and their equivalents, and all variations within the scope of the claims and their equivalents are to be construed as being included in the disclosure.

What is claimed is:

1. A user-centric work space (UCS) providing method performed by a UCS manager for UCS, wherein the UCS manager comprises a resource management functional entity (FE), and
the UCS providing method comprises:
receiving, by the resource management FE, capability information and status of UCS resources collected by a UCS device;
receiving, by the resource management FE, a UCS manager discovery request from a user device;
receiving, by the resource management FE, a UCS resource discovery request from the user device;
filtering, by the resource management FE, information received from the UCS device as available UCS resource information based on user device information; and
sending, by the resource management FE, the filtered information to the user device in response to the UCS resource discovery request.

2. The UCS providing method of claim 1, wherein the UCS manager further comprises a resource access control proxy FE and a connection control proxy FE, and
the connection control proxy FE is configured to relay controlling messages for data path management between the user device and the UCS device.

3. The UCS providing method of claim 1, wherein the receiving of the capability information and the status of the UCS resources comprises receiving, by the resource management FE, the capability information and status of UCS resources collected by a resource status monitoring FE of a device agent included the UCS device.

4. The UCS providing method of claim 1, wherein the receiving of the UCS manager discovery request comprises receiving, by the resource management FE, the UCS manager discovery request from a resource discovery FE of a user agent included in the user device.

5. The UCS providing method of claim 1, wherein the sending of the filtered information to the user device comprises sending, by the resource management FE, the filtered information to a resource discovery FE of a user agent included in the user device in response to the UCS resource discovery request.

6. The UCS providing method of claim 1, wherein the UCS manager further comprises a resource access control proxy FE,
the user device is a user device used by a predetermined user, and
the UCS providing method further comprises:
receiving, by the resource access control proxy FE of the UCS manager, a UCS resource access permission request from the user device of the predetermined user;
determining, by the resource access control proxy FE, if additional access control is required for the UCS resources;
detecting, by the resource access control proxy FE, a user device of a user who owns UCS resources requiring the additional access control;
forwarding, by the resource access control proxy FE, the UCS resource access permission request to the user device of the user who owns the UCS resources;
receiving, by the resource access control proxy FE, a resource permission granted from the user device of the user who owns the UCS resources; and
forwarding, by the resource access control proxy FE, the resource permission granted to the user device of the predetermined user.

7. The UCS providing method of claim 1, wherein the UCS manager further comprises a resource access control proxy FE, and
the UCS providing method further comprises:
receiving, by the resource access control proxy FE, a UCS resource permission request from the user device;
determining, by the resource access control proxy FE, if the UCS resources can be shared; and
sending, by the resource access control proxy FE, a UCS resource permission granted to the user device if the UCS resources can be shared.

8. The UCS providing method of claim 1, wherein the UCS manager further comprises a resource access control proxy FE,
the user device is a user device used by a predetermined user, and
the UCS providing method further comprises:
receiving, by the resource access control proxy FE, a UCS resource permission request from the user device of the predetermined user;
determining, by the resource access control proxy FE, if the UCS resources can be shared and if flow control is required;
detecting, by the resource access control proxy FE, a user device of a user who occupies the UCS resources if the UCS resources can be shared and the floor control is required;
sending, by the resource access control proxy FE, a resource permission revoked to the user device of the user who occupies the UCS resources; and
sending, by the resource access control proxy FE, a resource permission granted to the user device of the predetermined user.

9. A user-centric work space (UCS) providing method performed by a user device for UCS, wherein the user device performs the UCS providing method through a user agent comprising a device information management functional entity (FE), a resource discovery FE, a resource access control FE, and a connection control client FE, and
the UCS providing method comprises:
collecting, by the device information management FE, user information and user device information;
sending, by the resource discovery FE, a UCS manager discovery request;
selecting, by the resource discovery FE, UCS resources required for a UCS service based on UCS resource information received from a UCS manager;
sending, by the resource access control FE, an access permission request for the selected UCS resources to the UCS manager; and
starting, by the connection control client FE, connection setup with a device agent using the UCS manager.

10. The UCS providing method of claim 9, wherein the user agent further comprises a media control FE, and
the media control FE is configured to control receiving or sending media between user devices.

11. The UCS providing method of claim 9, wherein the sending of the access permission request comprises sending, by the resource access control FE, the access permission request for the selected UCS resources to a resource management FE included in the UCS manager.

12. The UCS providing method of claim 9, wherein the starting of the connection setup comprises starting, by the connection control client FE, the connection setup with the device agent using a connection control proxy FE included in the UCS manager.

13. The UCS providing method of claim 9, wherein the starting of the connection setup comprises starting, by the connection control client FE, connection setup with a connection control server FE included in the device agent using the UCS manager.

14. The UCS providing method of claim 9, wherein the sending of the access to permission request comprises receiving, by the resource access control FE, a UCS resource permission granted from a user device of a user who owns the UCS resources via the UCS manager.

15. The UCS providing method of claim 9, wherein the receiving comprises receiving, by the resource access control FE, a resource permission granted from a resource access control FE included in a user device of a user who owns the UCS resources via the UCS manager.

16. A user-centric work space (UCS) providing method performed by a UCS device for UCS, wherein the UCS device provides a UCS through a device agent comprising a resource status monitoring functional entity (FE) and a resource advertisement FE, and
the UCS providing method comprises:
collecting, by the resource status monitoring FE, capability information and availability status of each UCS resource; and
sending, by the resource advertisement FE, the collected capability information and status to a UCS manager.

17. The UCS providing method of claim 16, wherein the device agent further comprises a resource capability management FE and a media control FE,
the resource capability management FE is configured to store and manage capability information of UCS resources included in the UCS device, and
the media control FE is configured to control receiving or sending media between a user device and the UCS device.

18. The UCS providing method of claim 16, wherein the sending to the UCS manager comprises sending, by the resource advertisement FE, the collected capability information and status to a resource management FE included in the UCS manager.
